(19) United States
(12) Patent Application Publication
(10) Pub. No.: US 2008/0015833 A1
(43) Pub. Date: Jan. 17, 2008

(54) Methods and systems for molecular inhibition of protein misfolding

(75) Inventors: Edward K.Y. Jung, Bellevue, WA (US); Nathan P. Myhrvold, Medina, WA (US); Elizabeth A. Sweeney, Seattle, WA (US); Lowell L. Wood, Livermore, CA (US)

Correspondence Address: SEARETE LLC;CLARENCE T. TEGREENE, 1756 - 114TH AVE., S.E., SUITE 110, BELLEVUE, WA, 98004, US

(73) Assignee: Searete LLC, a limited liability corporation of the State of Delaware

(21) Appl. No.: 11/507,041

(22) Filed: Aug. 18, 2006

Related U.S. Application Data
(63) Continuation-in-part of application No. 11/487,180, filed on Jul. 13, 2006.
Application No. 11/487,180 is a continuation-in-part of application No. 11/487,133, filed on Jul. 13, 2006.

(51) Int. Cl. G06G 7/48; G06G 7/58

(52) U.S. Cl. 703/11

(57) ABSTRACT

Methods and systems are described which relate to polypeptide structural models and interacting molecule structures.

### CROSS-REFERENCE TO RELATED APPLICATIONS

The present application is related to and claims the benefit of the earliest available effective filing date(s) from the following listed application(s) (the “Related Applications”) (e.g., claims earliest available priority dates for other than provisional patent applications or claims benefits under 35 USC § 119(e) for provisional patent applications, for any and all parent, grandparent, great-grandparent, etc. applications of the Related Application(s)).

### Related Applications:

For purposes of the USPTO extra-statutory requirements, the present application constitutes a continuation-in-part of U.S. patent application Ser. No. 11/487,180, entitled Methods and Systems for Molecular Inhibition, naming Edward K. Y. Jung, Nathan P. Myhrvold and Lowell L. Wood, Jr. as inventors, filed 13 Jul. 2006

For purposes of the USPTO extra-statutory requirements, the present application constitutes a continuation-in-part of U.S. patent application Ser. No. 11/487,133, entitled Methods and Systems for Treating Disease, naming Edward K. Y. Jung and Lowell L. Wood, Jr. as inventors, filed 13 Jul. 2006, which are currently co-pending, or are an application of which a currently co-pending application is entitled to the benefit of the filing date. The United States Patent Office (USPTO) has published a notice to the effect that the USPTO's computer programs require that patent applicants reference both a serial number and indicate whether an application is a continuation or continuation-in-part. Stephen G. Kunin, Benefit of Prior-Filed Application, USPTO Official Gazette Mar. 18, 2003, available at http://www.uspto.gov/web/offices/com/sol/og/2003/week11/patbene.htm. The present applicant entity has provided above a specific reference to the application(s) from which priority is being claimed as recited by statute. Applicant entity understands that the statute is unambiguous in its specific reference language and does not require either a serial number or any characterization, such as “continuation” or “continuation-in-part,” for claiming priority to U.S. patent applications. Notwithstanding the foregoing, applicant entity understands that the USPTO's computer programs have certain data entry requirements, and hence applicant entity is designating the present application as a continuation-in-part of its parent applications as set forth above, but expressly points out that such designations are not to be construed in any way as any type of commentary and/or admission as to whether or not the present application contains any new matter in addition to the matter of its parent application(s). All subject matter of the Related Applications and of any and all parent, grandparent, great-grandparent, etc. applications of the Related Applications is incorporated herein by reference to the extent such subject matter is not inconsistent herewith.

### SUMMARY

In one aspect, a method includes but is not limited to: predicting a structural model of a first complex consisting essentially of a polypeptide molecule structure and a first interacting molecule structure; in response to the predicted structural model of the first complex, selecting a second interacting molecule structure predicted to associate with the first complex; predicting a structural model of a second complex consisting essentially of the first complex and the second interacting molecule structure; in response to the predicted structural model of the second complex, selecting a third interacting molecule structure predicted to associate with the second complex. In one aspect, a method includes but is not limited to: identifying at least one polypeptide; predicting at least one polypeptide structural model of at least one polypeptide; identifying that at least one polypeptide structural model has two or more potential conformations; identifying at least one structural model of at least one first interacting molecule that may associate with at least one of the potential conformations; predicting a structural model of a first complex consisting essentially of at least one polypeptide and at least one first interacting molecule; identifying at least one structural model of at least one second interacting molecule that may associate with the first complex; and predicting a structural model of a second complex consisting essentially of at least one polypeptide, at least one first interacting molecule and at least one second interacting molecule. In addition to the foregoing, other method aspects are described in the claims, drawings, and text forming a part of the present disclosure.

In one aspect, a system includes but is not limited to a computer readable medium including a computer program for use with a computer system, said computer program having one or more instructions including: one or more instructions for defining a model structure of a polypeptide molecule; one or more instructions for identifying a first interacting molecule structure predicted to be capable of associating with the polypeptide molecule structure; one or more instructions for defining a model structure of a complex consisting essentially of the polypeptide molecule structure in association with the first interacting molecule structure; and one or more instructions for identifying at least two additional interacting molecule structures that are predicted to be capable of associating with the polypeptide molecule structure and the first interacting molecule structure to form an inhibitory complex.

In addition to the foregoing, various other method and/or system and/or program product aspects are set forth and described in the teachings such as text (e.g., claims and/or detailed description) and/or drawings of the present disclosure.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

FIG. 1 is a flowchart of a method.

FIG. 2 is a flowchart of another method.

FIG. 3 is a diagram of a system.

FIG. 4 is a schematic of an aspect of methods and systems described herein.

FIG. 5 is another schematic of an aspect of methods and systems described herein.

FIG. 6 is a further schematic of an aspect of methods and systems described herein.

### DETAILED DESCRIPTION

Those having skill in the art will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

In one aspect, a method includes: predicting a structural model of a first complex consisting essentially of a polypeptide molecule structure and a first interacting molecule structure; in response to the predicted structural model of the first complex, selecting a second interacting molecule structure predicted to associate with the first complex; predicting a structural model of a second complex consisting essentially of the first complex and the second interacting molecule structure; and in response to the predicted structural model of the second complex, selecting a third interacting molecule structure predicted to associate with the second complex. In one aspect, a method includes: identifying at least one polypeptide; predicting at least one polypeptide structural model of at least one polypeptide; identifying that at least one polypeptide structural model has two or more potential conformations; identifying at least one structural model of at least one first interacting molecule that may associate with at least one of the potential conformations; predicting a structural model of a first complex consisting essentially of at least one polypeptide and at least one first interacting molecule; identifying at least one structural model of at least one second interacting molecule that may associate with the first complex; and predicting a structural model of a second complex consisting essentially of at least one polypeptide, at least one first interacting molecule and at least one second interacting molecule.

Molecule structures predicted and selected through the methods and systems described herein are thought to be particularly beneficial in regard to applications such as combinatorial chemistry, pharmaceutical discovery, pharmaceutical testing and research, although they are not limited to those embodiments or applications. In particular, methods and systems as described herein may be beneficial with regard to applications relating to polypeptides, including applications involving polypeptides with multiple conformations. In some situations, the primary, secondary or tertiary structure of polypeptides may have alternate conformations with different biochemical properties, including disease states associated with at least one conformation. See, for example, Soto et al., “Amyloids, Prions and the Inherent Infectious Nature of Misfolded Protein Aggregates”, Trends in Biochemical Sciences 31: 150-155 (2006), which is herein incorporated by reference.

As used herein, the term “structural model” refers to a model of a structure, such as that of a molecule or group of molecules. Similarly, as used herein a “molecule structure” refers to a structural descriptor, or definition of a particular molecule or class of molecules or an actual structure represented by such model descriptor or definition. A structural model or molecule structure may include a molecule or molecules in their entirety or it may include only a portion of a molecule or molecules. As used herein a structural model includes, but is not limited to, chemical, atomic and physical models, which may include tertiary structure and may include: one or more atomic coordinates, linear diagrams, space-filling structures or predictions, geometric predictions, structures based on functional groups, structures based on energy states, or structures based on chemical or molecular bonds. The structural models contemplated herein may or may not be visually presented and may or may not be represented in a physical form. Structural models may include at least one prediction of the 3-dimensional structure of a molecule or molecules. Structural models may be based on physical models, such as those described in Lezon et al. “What Determines the Spectrum of Protein Native State Structures?”, Proteins: Structure, Function, and Bioinformatics 63: 273-277 (2006), which is herein incorporated by reference. A structural model may be based entirely or in part on experimentally based data, such as nucleic acid or protein sequences, X-ray crystal structures or nuclear magnetic resonance (NMR) data, the structural model may be based entirely or in part on ab initio predictions, or may be based in whole or in part on a combination of such techniques or other techniques as may be appropriate. For an example of structural models based in part on NMR data, see Jaroniec et al., “High-resolution Molecular Structure of a Peptide in an Amyloid Fibril Determined by Magic Angle Spinning NMR Spectroscopy”, Proceedings of the National Academy of Sciences (USA) 101: 711-716 (2004), which is herein incorporated by reference. For an example of the use of both optical and NMR analysis as the basis for structural models, see Jahn et al., “Amyloid Formation Under Physiological Conditions Proceeds Via a Native-like Folding Intermediate”, Nature Structural and Molecular Biology 13: 195-201 (2006), which is herein incorporated by reference. In some embodiments, structural models can be based on a combination of experimentally based and predictive techniques. Structural models may be generated by any one of a number of techniques known to those of skill in the art. These include the use of commercially available computer programs such as ChemDraw (sold by Cambridgesoft), HyperChem (sold by Hypercube, Inc.), ICM (sold by MolSoft) and Catalyst (sold by Accelrys), or computer programs that are freeware or shareware such as RasMol (available at http://www.umass.edu/microbio/rasmol/), Protein Explorer (available at http://www.umass.edu/microbio/chime/pe/protexpl/frntdoor.htm), TopPred II, or ArgusLab (available at http://www.planaria-software.com/). In some embodiments, the structural models may already exist in databases such as the publicly accessible Entrez Structure, which is made available through the NCBI (available at http://www.ncbi.nlm.nih.gov/entrez/query.fcgi?db=Structure). In some embodiments, multiple conformations may exist as variants of a structural model, and conformational entropy at physiological or near-physiological conditions may be taken into account when predicting one or more structural models. For an example of multiple models with different relative structural forms, see Kammerer et al., “Exploring Amyloid Formation by a De Novo Design”, Proceedings of the National Academy of Sciences (USA), 101: 4435-4440 (2006), which is herein incorporated by reference. In some embodiments, multiple related structural models, such as isomers or chiral forms, may be predicted based on the same molecular constituents. In some embodiments, polypeptide structural models may be inherently flexible, such as the structures described in Bhalla et al., “Local Flexibility in Molecular Function Paradigm”, Molecular Cell Proteomics 5:1212-1223 (2006), which is herein incorporated by reference. As a non-limiting example of methods to predict structural models of polypeptides, see Kuhlman B. et. al., “Design of a Novel Globular Protein Fold with Atomic-Level Accuracy”, Science 302:1364-1368, (2003), which is herein incorporated by reference.

As used herein, the term “polypeptide” refers to at least one molecule including at least two amino acids linked together through amide bonds. Polypeptides may be of any number of amino acids and may have primary, secondary or tertiary structure. In some embodiments, a polypeptide may be comprised of more than one molecule and the polypeptide molecule structure may include at least two polypeptide units. In some embodiments, a polypeptide is known to have enzymatic activity, is predicted to have enzymatic activity, or is part of a group wherein some members have enzymatic activity, or the polypeptide molecule structure is associated with enzymatic activity. Some embodiments include predicting a structural model of the polypeptide molecule structure. The model structure of a polypeptide molecule may include alternate conformations. At least one alternate conformation may be associated with a disease state. The polypeptide molecule structure may be predicted to include at least one of: beta-sheet structure, polypeptide aggregate structure, or fibril structure. Similarly, at least one potential conformation of at least one polypeptide structural model is predicted to include at least one of: beta-sheet structure, polypeptide aggregate structure or fibril structure. More details regarding specific structures that may be present in polypeptides is available in Lezon et al., “What Determines the Spectrum of Protein Native State Structures?”, Proteins: Structure, Function, and Bioinformatics 63: 273-277 (2006), and Hoang et al., “Common Attributes of Native-state Structures of Proteins, Disordered Proteins, and Amyloid”, Proceedings of the National Academy of Sciences (USA) 103: 6883-6888 (2006), which are herein incorporated by reference. More information regarding amyloid fiber structure formation may be found in Miranker, Proceedings of the National Academy of Sciences (USA), “Unzipping the Mysteries of Amyloid Fiber Formation” 101:4335-4336 (2006), which is herein incorporated by reference. In some embodiments, a polypeptide molecule is capable of acting as a biological chaperone or may be associated with a biological chaperone in at least some biological systems. For more information regarding biological chaperones and their relationship to polypeptide structure, see True, “The Battle of the Fold: Chaperones Take on Prions”, Trends in Genetics 22: 110-117 (2006), and Alexendrescu, “Amyloid Accomplices and Enforcers”, Protein Science 14:1-12 (2005), which are herein incorporated by reference.

In some embodiments, a polypeptide molecule is associated with a disease state, which includes but is not limited to circumstances where the polypeptide molecule is directly associated with a disease state, for example is a cause or part of a cause of, is a promoter of, is the result of or a byproduct of a disease state. As used herein, “disease state” may include any form of pathology such as metabolic states that are disruptions to normal metabolic stasis, including, for example, subnormal metabolic activity, abnormal metabolic activity, an increased tendency to neoplasia and increased tendency to dementia. In some embodiments, at least one potential conformation of at least one polypeptide structural model is associated with a disease state. For more information regarding the association of particular conformations of polypeptide structural models with disease states, see: Chaudhuri and Paul, “Protein-misfolding Diseases and Chaperone-based Therapeutic Approaches”, FEBS Journal 273:1331-1349 (2006); Dobson, “In the Footsteps of Alchemists”, Science 304: 1259-1262 (2004); Gandy “The Role of Cerebral Amyloid β Accumulation in Common Forms of Alzheimer Disease”, The Journal of Clinical Investigation 115: 1121-1129 (2005); and Kirkitadze and Kowalska, “Molecular Mechanisms Initiating Amyloid α-fibril Formation in Alzheimer's Disease”, Acta Biochimica Polonica 52: 417-423 (2005), which are incorporated herein by reference. For more information regarding mechanisms of the relationship between polypeptides and disease states, see Meredith, “Protein Denaturation and Aggregation: Cellular Responses to Denatured and Aggregated Proteins”, Annals of the New York Academy of Sciences 1066: 181-221 (2005), which is herein incorporated by reference. In some embodiments, the polypeptide molecule structure corresponds to a molecule that is causally associated with a disease state in at least one of: a human, a non-human mammal or an animal. The polypeptide molecule may also be associated with a disease state in at least one of: a human, a domestic animal, or a non-domestic animal. While it is contemplated that the methods and systems described herein will be applicable to complexes of molecule structures corresponding to molecules that are suitable for use in the treatment of diseases in humans and other mammals, including domestic and non-domestic animals, the methods and systems described herein are not limited to those applications. Other applications for the methods and systems described herein also include, as non-limiting examples, predicting complexes including plant pathogens, bacteriophages and pathogens affecting non-mammalian animals. Methods and systems may include embodiments in vivo and in vitro.

As used herein, an “interacting molecule” is a molecule that associates, for example, with another molecule or group of molecules in a manner that alters the activity of the group of molecules, is predicted to alter the activity of at least one molecule, or is predicted to form a complex in such a manner so as to alter the predicted ability of a polypeptide molecule structure or group to include or exist as one or more particular structures such as beta sheet structure, polypeptide aggregate structure or fibril structure. In some embodiments, there is an “interacting molecule structure”, which refers to a structural descriptor, or definition of a particular molecule or class of molecules, or an actual structure represented by such model descriptor or definition. Two or more interacting molecule structures of the same or different types may be predicted to associate with a complex of one or more interacting molecule structures and one or more polypeptide molecule structures. In some embodiments, the interacting molecule structures and the complex structure are predicted to associate based on their respective structures and principles of molecular interactions. Although it is anticipated that at least three interacting molecules of the same or different types will be predicted to associate with each polypeptide molecule to form a complex, one of skill in the art will appreciate that the precise number and type of molecules predicted to associate in any complex will depend on a number of parameters present in any given embodiment and may vary over time and in different environmental conditions. Some embodiments include predicting a structural model of a third complex, which consists essentially of the second complex and the third interacting molecule structure. In some embodiments, a series of N additional interacting molecule structures are selected, wherein each interacting molecule structure is predicted to associate with the N−1 complex. For example, it may be that a series of four interacting molecule structures are selected, wherein each interacting molecule structure is predicted to associate with the third complex. Some embodiments include identifying a plurality of additional interacting molecule structures. Embodiments may also include predicting a structural model of a polypeptide molecule structure in complex with a plurality of identified interacting molecule structures.

Depending on the embodiment, interacting molecule structures may be selected from a previously identified group of potential interacting molecule structures or any other group of previously identified molecule structures. “Selection” may include the identification of an interacting molecule or interacting molecule structure as appropriate to the embodiment, and may include selection based on desired characteristics of the polypeptide molecule structure, interacting molecule or interacting molecule structure such as size, shape, conformation or chemical properties. For example, at least one interacting molecule or interacting molecule structure may be selected in reference to the ability of the molecule or molecule structure to interact with an aggregation inhibiting protein or protein structure as well as the polypeptide molecule or polypeptide molecule structure. For more information regarding molecule structures including an aggregation inhibiting protein interaction domain as well as another interaction domain, see U.S. Patent Application 2005/0209173 to Graef et al entitled Neurodegenerative Protein Aggregation Inhibition Methods and Compounds. As an example, interacting molecule structures may be selected from a group containing polyphenol structures, such as those described by Porat et al., Chem Biol Drug Des 67: 27-37 (2006), incorporated herein by reference. In some embodiments, selection is made in response to another structure or the characteristics of another structure, including the stability of another structure. Some embodiments may include selecting a series of N additional interacting molecule structures wherein each interacting molecule structure is predicted to associate with the N−1 complex. Embodiments include predicting a structural model of each of N complexes which consist essentially of the N−1 complex and the N interacting molecules. Some embodiments include selecting a series of N additional structural models of interacting molecules, wherein each structural model is predicted to associate with the N−1 complex structural model. Selecting any interacting molecule may include a 3-dimensional structure prediction and/or accessing information regarding crystal structure and/or retrieving information from a database. Selection of any interacting molecule may also be performed with electrical circuitry, which may include a processor and/or a memory containing computer instructions. As will be recognized by one of skill in the art, the interactions of some molecules or molecular structures may initiate or stabilize a predictable conformational change and therefore additional molecules or molecule structures may be selected in response to this change. In some embodiments, a group of molecules or molecule structures is first identified and then one or more selections are made subsequently. When a group of molecules or molecule structures are identified in advance of selection, the group may be a set of candidate molecules or molecule structures. An example would include selecting two or more identified molecules in reference to their predicted molecule structures as a group.

As used herein, a “complex” is a group of molecule structures that are or are predicted to be capable of association at a molecular level. As used herein, “predicted” may include a purely hypothetical prediction, an analytically derived prediction, structurally identified predictions including computer modeled structures, a prediction based on prior experimental data, a probabilistic assessment, or a combination of these or other appropriate prediction approaches. Predicting a structural model of at least one complex may be performed with electrical circuitry, which may include a processor and/or a memory containing computer instructions. Predicting a structural model of at least one complex may also include accessing information regarding crystal structure or other structure and/or retrieving information from a database. In some embodiments, complexes consist of structural models in their entirety while in others complexes include one or more partial structural models. The molecule structures or portions of molecule structures involved in a complex may be predicted to associate by any mechanism, including but not limited to covalent bonding, van der Waals forces, physical force, ionic forces, electrostatic interactions, hydrogen bonds and hydrophobic interactions. In some embodiments, complexes may be predicted by computer software such as ChemDraw (sold by Cambridgesoft), HyperChem (sold by Hypercube, Inc.), ICM (sold by MolSoft), Gaussian (sold by Gaussian, Inc.) and Catalyst (sold by Accelrys). In some embodiments, the complex is based on experimental data such as X-ray crystal structures or NMR data (see for example Istvan, E. S. and Deisenhofer J., “Structural Mechanism for Statin Inhibition of HMG-CoA Reductase”, Science 292:1160-1164, (2001), and Wang C. E., “ConfMatch: Automating Electron-Density Map Interpretation by Matching Conformations”, Acta Crystallographica (Section D) D56: 1591-1611 (2000), which are herein incorporated by reference). Some methods to model polypeptide structures and the association of polypeptide structures are described in U.S. Pat. No. 6,560,542 to Mandell et al. entitled Algorithmic Design of Peptides for Binding and/or Modulation of the Functions of Receptors and/or other Proteins and U.S. Pat. No. 6,865,492 to Mandell et al entitled Algorithmic Design of Peptides for Binding and/or Modulation of the Functions of Receptors and/or other Proteins. In some embodiments, the complex is based on homology with experimentally known interactions (see for example PIP, available at http://www.bmm.icnet.uk/˜pip/). In some embodiments, the structural models are predicted to “associate” together, which as used herein refers to an interaction that has some stability for some time period, although it may be transient. In some embodiments, predicting a structural model of the first complex includes at least one of: a 3-dimensional structure prediction, a space-filling structure prediction, a linear model structural prediction, a dynamic structural prediction or a structural model including molecular energy states. In some embodiments, the complexes are predicted to form by direct association of all of the molecule structures in the complex while in others some of the associations between molecule structures in the complex are remote or indirect. Some embodiments may include predicting a structural model of a complex, consisting essentially of a previously predicted complex and an interacting molecule structure. An example is predicting a structural model of a third complex, which consists essentially of the second complex and the third interacting molecule structure. In some embodiments, the structural model of the second complex predicts that the second interacting molecule structure associates with both the polypeptide molecule structure and the first interacting molecule structure. In some embodiments the structural model of the second complex predicts that the second interacting molecule structure directly associates with the polypeptide molecule structure. In some embodiments the structural model of the second complex predicts that the second interacting molecule structure does not directly associate with the polypeptide molecule structure. In some embodiments, the structural model of the third complex predicts that the third interacting molecule structure directly associates with the polypeptide molecule structure, the first interacting molecule structure and the second interacting molecule structure simultaneously. In some embodiments, the structural model of the third complex predicts that the third interacting molecule structure directly associates with the polypeptide molecule structure. In some embodiments, the structural model of the third complex predicts that the third interacting molecule structure does not directly associate with the second interacting molecule structure. Embodiments include those predicting a structural model of each of N complexes, which consist essentially of the N−1 complex and the N interacting molecule structures. In addition, the selection of each additional interacting molecule structure may be in response to the predicted stability of the interaction between the molecule structures forming the most recently predicted complex.

In some situations it may be desirable to include structural models corresponding to polypeptides and/or interacting molecules with specific properties. For example, it may be desirable to include interacting molecular structures corresponding to molecules that are predicted to interact with at least one enzyme, such as a protease, secretase, or glycosylase. For example, it may be desirable to include interacting molecular structures corresponding to molecules that are predicted to interact with at least one molecule that is associated with a cellular protein degradation pathway. At least one molecule may be predicted to interact with ubiquitin. Embodiments also include those wherein at least one of the interacting molecule structures corresponds to a molecule that is associated with enzymatic modification of polypeptides and those wherein at least one of the interacting molecule structures corresponds to a molecule that is associated with a cellular degradation mechanism.

In some embodiments, it may be desirable to create or obtain molecules corresponding to molecular structures such as those identified, predicted and/or selected herein and to examine the association of those molecules in vitro or in vivo. In addition, in some embodiments it may be desirable to detect the interaction and/or association between molecules corresponding to molecular structures identified, predicted and/or selected herein. Multiple methods exist to detect the interaction and/or association between molecules corresponding to molecular structures such as those described herein. Any detection technique known to those of skill in the art or described herein may be used to detect the interaction between molecules corresponding to molecular structures. Detection methods include for example chemiluminescent, fluorescent or radioactive based techniques as well as those that use impinging electromagnetic energy, such as ultraviolet, infra-red or visible light. Any method known to those of skill in the art or described herein may be used to test the interaction of molecules corresponding to predicted complexes and associations between molecular structures, including fluorescent quenching, phage display, Fluorescence Resonance Energy Transfer (FRET), Enzyme-Linked Immunosorbent Assay (ELISA), electrophoresis-based methods and polymerase-chain reaction (PCR)-based techniques.

In some embodiments, the stability of one or more molecule structures or complexes is predicted. As used herein, “stability” includes stability of the molecular structure, including conformation and chemical composition, within the normal parameters of a given embodiment as well as the predicted constancy of the associations or interactions between the structures within a complex over time or between different environmental conditions. Stability may be predicted by any one of a number of methods, including but not limited to those that utilize thermal, conformational or chemical predictions or in reference to experimental findings. Complexes may be predicted to be stable over time or they may be predicted to be transitory. Stability may be predicted based on energy minimization. In some embodiments, stability is predicted based on the conformational entropy of the molecule or molecules themselves. As will be recognized by a person of skill in the art, molecules and molecular structures are inherently somewhat dynamic depending on the environment and therefore stability can vary over time and between known or predicted environmental conditions. Depending on the embodiment, predictions of stability may be based on known or predicted thermodynamic properties, and may comprise a range respective to particular temperatures and conditions. Some embodiments include predicting the thermodynamic stability for the structure of at least one complex and may also include identifying at least one interacting molecule structure based on the predicted thermodynamic stability of the structure of at least one complex. In some embodiments, predictions of stability may be based on known or predicted conditions of a given organism, including temperature, metabolic chemistry and the presence or absence of stability-influencing molecules, such as stability-enhancing or stability-decreasing molecules. In some embodiments, the stability of the interaction between the molecule structures forming the first complex and/or the stability of the interaction between molecule structures forming any subsequent complex are predicted. It is possible to select the second interacting molecule structure in response to the predicted stability of the interaction between the molecule structures forming the first complex.

In some embodiments, the activity of molecules corresponding to one or more molecular structures or complexes is predicted. “Activity” may be, for example, a biochemical activity as described above, or it may be a physical or chemical activity that is not limited to biochemical environments. Examples of a physical or chemical activity include thermodynamic stability, the potential to interact with other molecules, radioactivity, chemiluminescence, electron transfer, and magnetic potential. Activity includes the tendency to form multimeric units, such as the tendency of polypeptides to form aggregate structures. Any activity or alteration in type or level of activity may be part of a prediction. Some embodiments include predicting potential activity of a polypeptide molecule corresponding to the polypeptide molecule structure associated with the first complex and/or predicting potential activity of molecules corresponding to molecular structures associated with the first, second and/or third complex. Some embodiments include selecting the second interacting molecule structure in response to the predicted activity of molecules corresponding to molecular structures associated with the first complex, and/or selecting the third interacting molecule structure in response to the predicted activity of molecules corresponding to molecular structures associated with the second complex.

In some embodiments, the toxicity of molecules corresponding to molecular structures is predicted. Predictions regarding toxicity may be based on one or a combination of methods, including in silico, in vitro or in vivo experimental predictions or structural predictions. Experimental methods to predict toxicity include, for example, cell culture testing, mutagenesis assays, teratogenesis assays, LD50 assays and skin irritation assays. Toxicity may also be predicted based on molecular structure or inclusion in a chemical class known to have toxic properties. Toxicity may be predicted to be acute or to occur over time with repeated doses. Toxicity may be predicted based on a molecule acting alone or by the action of a combination of molecules. Some embodiments include identifying a set of candidate interacting molecules that are predicted to not be toxic to a mammal, selecting a first interacting molecule from the identified set of candidate interacting molecules, and predicting the molecule structure of the identified first interacting molecule. Embodiments may also include identifying a set of candidate interacting molecules, predicting the toxicity of the identified candidate interacting molecules and predicting the molecule structure of a group of the identified candidate interacting molecules. Embodiments may include selecting identified molecules having a predicted toxicity below a selected level. In some embodiments, the interacting molecule structures correspond to molecules that are associated with minimal toxicity to at least one of: a human, a domestic animal or a non-domestic animal. As used herein, “minimal toxicity” refers to a toxicity that is acceptable in a given embodiment, application, or approach. In some embodiments, a molecule or molecules corresponding to the first interacting molecule structure and/or at least one additional interacting molecule structure are predicted to be nontoxic to a human.

Systems as described herein include those with a computer readable medium including a computer program for use with a computer system, said computer program having one or more instructions including: one or more instructions for defining a model structure of a polypeptide molecule; one or more instructions for identifying a first interacting molecule structure predicted to be capable of associating with the polypeptide molecule structure; one or more instructions for defining a model structure of a complex consisting essentially of the polypeptide molecule structure in association with the first interacting molecule structure; and one or more instructions for identifying at least two additional interacting molecule structures that are predicted to be capable of associating with the polypeptide molecule structure and the first interacting molecule structure to form an inhibitory complex. Systems may include one or more instructions for defining a model structure of the inhibitory complex. Systems may also include: one or more instructions for predicting the probability of association of at least two alternate conformations of the molecule structure of the polypeptide molecule with at least one interacting molecule structure; and one or more instructions for selecting an interacting molecule structure in reference to the probability of association. Systems may include one or more instructions for predicting the response of at least one cell to molecules corresponding to the molecule structures of the inhibitory complex. Systems may include one or more instructions for predicting the toxicity of: at least one interacting molecule, or the inhibitory complex and may also include one or more instructions for selecting at least one interacting molecule in reference to a predicted toxicity.

Further aspects of the methods and systems described herein are described in the Figures as discussed below.

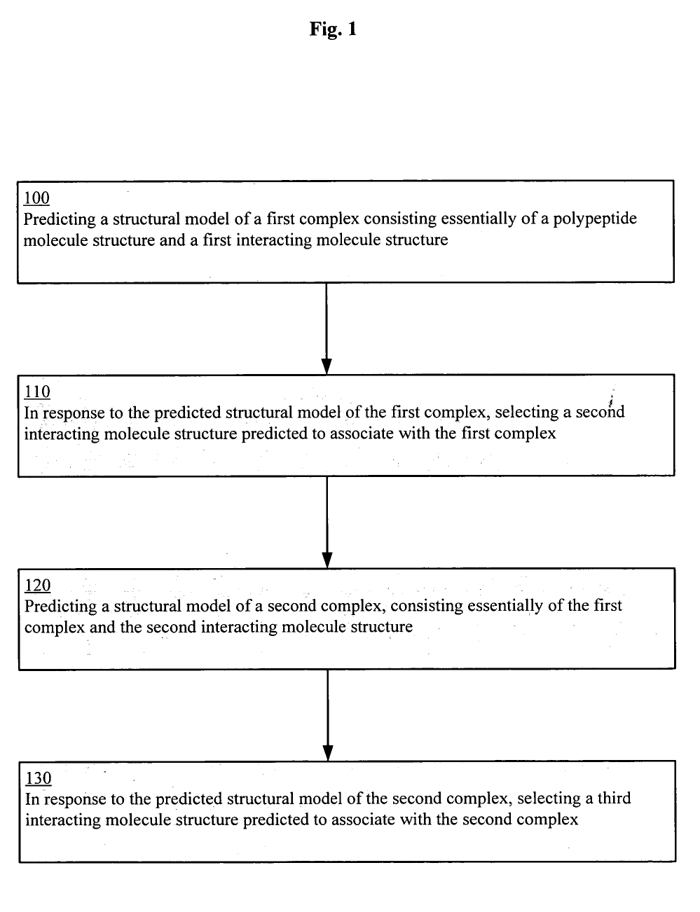

FIG. 1 is a flowchart of a method as described herein. The method includes step 100 for predicting a structural model of a first complex consisting essentially of a polypeptide molecule structure and a first interacting molecule structure. The polypeptide molecule structure may be identified through experimental analyses, predictive analyses, the additional approaches for prediction described herein, or may be received from a separate source, or any combination thereof. The polypeptide molecule structure and the first interacting molecule structure may be identified in any sequence or simultaneously. In one approach, identifying the first interacting molecule structure includes identifying one or more interacting molecule structures that are predicted to associate with variable specificity and stability to the polypeptide molecule structure to form one or more respective complexes that include the polypeptide molecule structure. For clarity of presentation, the one or more respective complexes will be referred to subsequently as the first complex, the second complex, and so on, although the complexes may be identified in varying sequences in different embodiments. The method continues with step 110, which includes selecting a second interacting molecule structure predicted to associate with the first complex, wherein the selecting is in response to the predicted structural model of the first complex. For example, a selection could be based directly on the structural model of the first complex, or the selection(s) could be based in whole or in part based on the polypeptide molecule structure and/or the first interacting molecule structure. The method also includes step 120 for predicting a structural model of a second complex, consisting essentially of the first complex and the second interacting molecule structure. The method continues with step 130 selecting a third interacting molecule structure predicted to associate with the second complex, wherein the selecting is in response to the predicted structural model of the second complex.

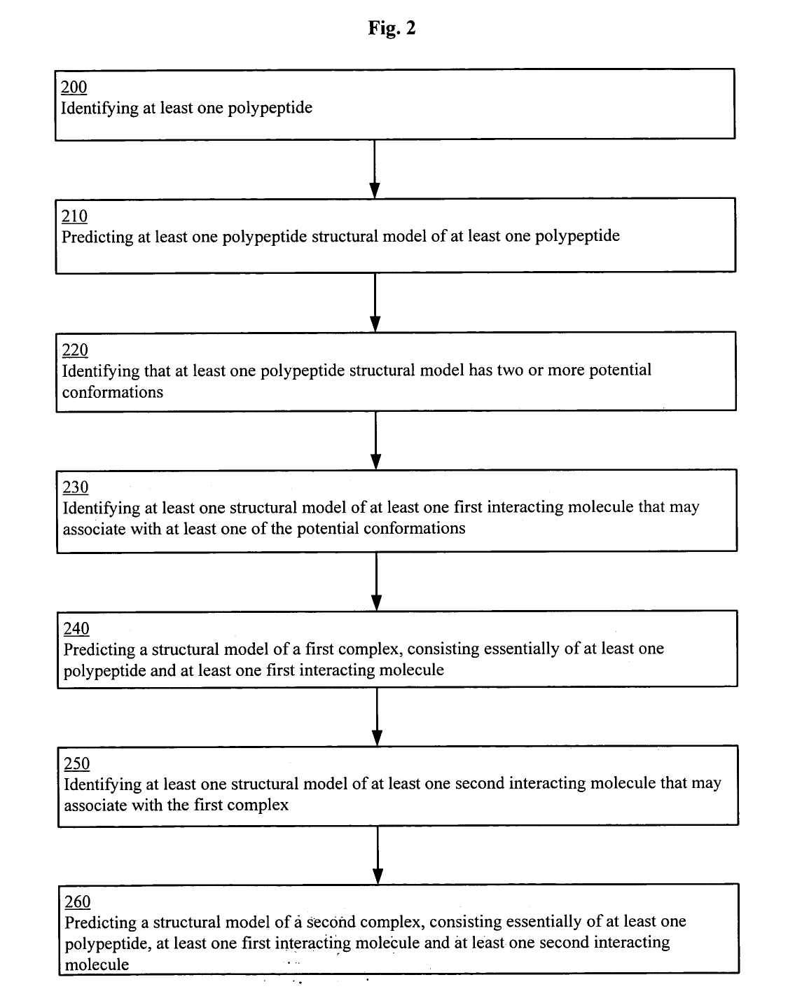

FIG. 2 is a flowchart illustrating further aspects of a method. Step 200 illustrates identifying at least one polypeptide. The polypeptide may be identified by any means known to those of skill in the art or described herein. For example, the polypeptide may be identified from a group or listing of polypeptides or it may be identified based on its amino acid composition, amino acid sequence, inclusion in a group of polypeptides, or chemical properties. In some embodiments, the polypeptide has alternate conformations and a particular conformation may be identified. In some embodiments, the polypeptide is identified based on, for example, its pathogenicity, toxicity, or its association with a disease state. Step 210 includes predicting at least one polypeptide structural model of at least one polypeptide. The polypeptide structural model may be predicted by any means known to those of skill in the art or described herein. In some embodiments, the polypeptide has multiple potential structural models corresponding to alternate conformations of the polypeptide, and two or more structural models may be predicted. Step 220 includes identifying that at least one polypeptide structural model has two or more potential conformations. In some embodiments, the stability of the potential conformations may be predicted. In some embodiments, the conformations may include beta sheet structure, aggregate structure, or fibril structure. Step 230 provides for identifying at least one structural model of at least one first interacting molecule that may associate with at least one of the potential conformations. A structural model of an interacting molecule may be identified by any means known to those of skill in the art or described herein. For example, the structural model of an interacting molecule may be identified from a group or listing of structural models or it may be identified based on its inclusion in a group of structural models, or based on the chemical properties of the corresponding molecule. In some embodiments, identifying a structural model may include identifying a portion of a structural model, for example a particular region, area or location of a molecule. The structural model may associate with the potential conformation of a polypeptide structural model by any means known to those of skill in the art or described herein. Step 240 illustrates predicting a structural model of a first complex consisting essentially of at least one polypeptide and at least one first interacting molecule. A structural model may be predicted by any means known to those of skill in the art or described herein. The structural model may further include aspects particular to a given embodiment, for example stability, or hydration. Step 250 illustrates identifying at least one structural model of at least one second interacting molecule that may associate with the first complex. Although the interacting molecules are described as “first”, “second”, etc. for the purposes of clarity, they may be identified in any order or sequence, or identified simultaneously. For example, the first and second interacting molecules may be identified based on their inclusion in a group or listing. The first and second interacting molecules need not associate directly with each other. Step 260 illustrates predicting a structural model of a second complex consisting essentially of at least one polypeptide, at least one first interacting molecule and at least one second interacting molecule. Although the complexes are described as “first”, “second”, etc. for the purposes of clarity, they may be identified in any order or sequence, or identified simultaneously.

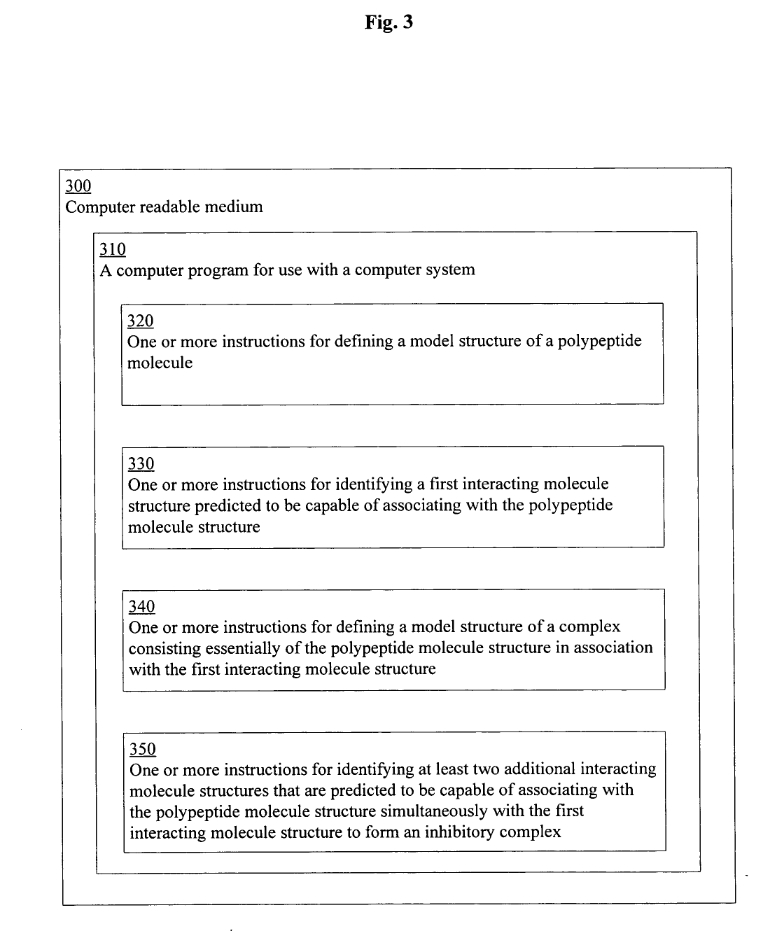

FIG. 3 is a diagram of an illustrative system. A computer readable medium 300 includes a computer program for use with a computer system 310. A computer program for use with a computer system 310 includes one or more instructions. Although instructions are shown in a particular order in FIG. 3, they may be carried out in any order or simultaneously. Instructions include one or more instructions for defining a model structure of a polypeptide molecule, 320. Defining a model structure of a peptide molecule may be carried out in any manner known to those of skill in the art or described herein, including through pre-existing software. Instructions further include one or more instructions for identifying a first interacting molecule structure predicted to be capable of associating with the polypeptide molecule structure, 330. A molecule structure may be identified in any manner known to those of skill in the art or described herein, including through inclusion in a group or class of molecule structures. Instructions include one or more instructions for defining a model structure of a complex consisting essentially of the polypeptide molecule structure in association with the first interacting molecule structure 340. Defining a model structure of the polypeptide molecule structure in association with the first interacting molecule structure may be carried out in any manner known to those of skill in the art or described herein, including through pre-existing software. Instructions include one or more instructions for identifying at least two additional interacting molecule structures that are predicted to be capable of associating with the polypeptide molecule structure and the first interacting molecule structure to form an inhibitory complex, 350. The interacting molecule structures may or may not associate directly with each other, depending on the embodiment.

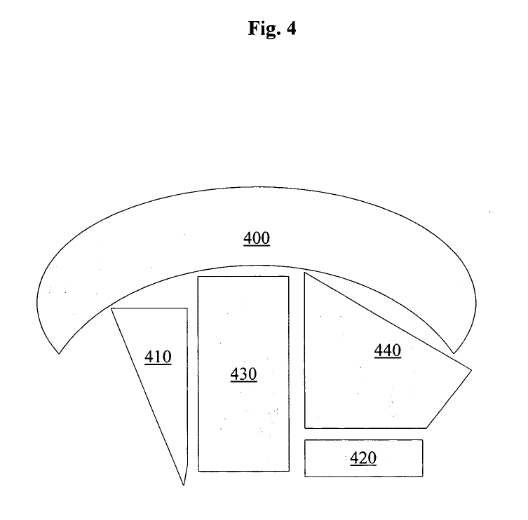

FIGS. 4, 5 and 6 show representative diagrams of some potential configurations of molecule structures such as those that may be identified through the methods and systems described herein.

FIG. 4 shows a potential association of molecular structures, including polypeptide molecule structure 400. In association with polypeptide molecule structure 400 are interacting molecule structures 410, 420, 430 and 440. As is visually displayed in this Figure, each of the interacting molecule structures need not directly associate with each other or with the polypeptide molecule structure. For example, interacting molecule structure 420 associates directly with interacting molecule structures 430 and 440 but not with interacting molecule structure 410 or polypeptide molecule structure 400.

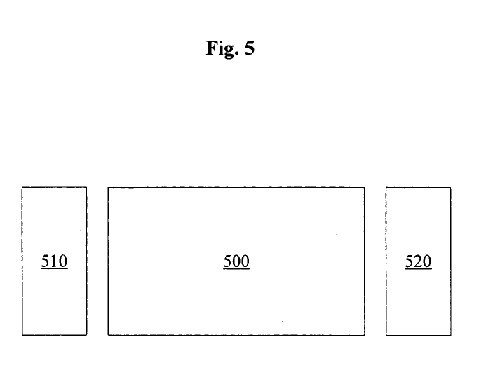

FIG. 5 shows an alternative potential association of a polypeptide molecule structure and interacting molecule structures. Polypeptide molecule structure 500 associates with both interacting molecule structures 510 and 520, although structures 510 and 520 do not directly associate with each other. In some embodiments, interacting molecule structures in an arrangement similar to that shown in FIG. 5 would alter the potential of polypeptide molecule structure 500 to adopt a particular conformation, for example to reduce the potential of polypeptide molecule structure 500 to form beta sheet structure, aggregate structure, or fibril structure.

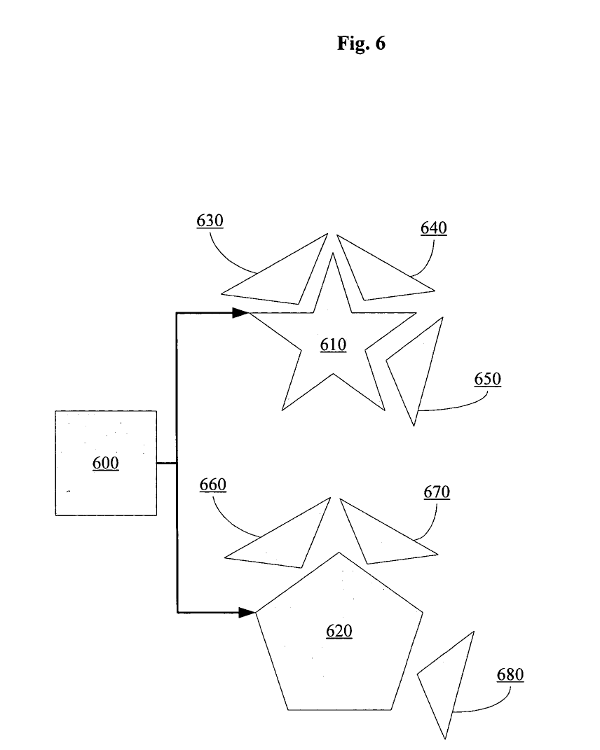

FIG. 6 illustrates the potential for interacting molecule structures to associate with a particular conformation of a polypeptide molecule structure and not with another potential conformation of a polypeptide molecule structure. Polypeptide molecule structure 600 has the potential to adopt at least two molecule structures, conformation 610 and conformation 620. Interacting molecule structures 630, 640 and 650 have the potential to associate with conformation 610. However molecule structures 660, 670 and 680, which are respectively equivalent to interacting molecule structures 630, 640 and 650, do not associate with conformation 620.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, etc.).

In a general sense, those skilled in the art will recognize that the various aspects described herein which can be implemented, individually and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment). Those having skill in the art will recognize that the subject matter described herein may be implemented in an analog or digital fashion or some combination thereof.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

All of the above U.S. patents, U.S. patent application publications, U.S. patent applications, foreign patents, foreign patent applications and non-patent publications referred to in this specification and/or listed in any Application Data Sheet, are incorporated herein by reference, in their entireties.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A method comprising:
predicting a structural model of a first complex consisting essentially of a polypeptide molecule structure and a first interacting molecule structure;
in response to the predicted structural model of the first complex, selecting a second interacting molecule structure predicted to associate with the first complex;
predicting a structural model of a second complex consisting essentially of the first complex and the second interacting molecule structure; and
in response to the predicted structural model of the second complex, selecting a third interacting molecule structure predicted to associate with the second complex.

2. The method of claim 1, wherein the polypeptide molecule structure includes at least two polypeptide units.

3. The method of claim 1, wherein the polypeptide molecule structure is associated with enzymatic activity.

4. The method of claim 1, further comprising:
predicting a structural model of the polypeptide molecule structure.

5. The method of claim 4, wherein the polypeptide molecule structure is predicted to include at least one of: beta-sheet structure, polypeptide aggregate structure, or fibril structure.

6. The method of claim 1, wherein a polypeptide molecule corresponding to the polypeptide molecule structure is associated with a disease state.

7. The method of claim 1 further comprising:
predicting a structural model of a third complex which consists essentially of the second complex and the third interacting molecule structure.

8. The method as in claim 1, further comprising:
predicting the stability of the interaction between the molecule structures forming the first complex.

9. The method as in claim 8 further comprising:
selecting the second interacting molecule structure in response to the predicted stability of the interaction between the molecule structures forming the first complex.

10. The method as in claim 1 further comprising:
selecting a series of N additional interacting molecule structures wherein each interacting molecule structure is predicted to associate with the N−1 complex.

11. The method of claim 10 further comprising:
predicting a structural model of each of N complexes which consist essentially of the N−1 complex and the N interacting molecule structures.

12. The method as in claim 11 wherein the selection of each additional interacting molecule structure is in response to the predicted stability of the interaction between the molecule structures forming the most recently predicted complex.

13. The method as in claim 1 wherein the structural model of the second complex predicts that the second interacting molecule structure associates with both the polypeptide molecule structure and the first interacting molecule structure.

14. The method as in claim 1 wherein the structural model of the second complex predicts that the second interacting molecule structure directly associates with the polypeptide molecule structure.

15. The method as in claim 1 wherein the structural model of the second complex predicts that the second interacting molecule structure does not directly associate with the first interacting molecule structure.

16. The method as in claim 1 wherein the structural model of the third complex predicts that the third interacting molecule structure directly associates with the polypeptide molecule structure, the first interacting molecule structure and the second interacting molecule structure simultaneously.

17. The method as in claim 1 wherein the structural model of the third complex predicts that the third interacting molecule structure directly associates with the polypeptide molecule structure.

18. The method as in claim 1 wherein the structural model of the third complex predicts that the third interacting molecule structure does not directly associate with the second interacting molecule structure.

19. The method as in claim 1 further comprising:
predicting potential activity of a polypeptide molecule corresponding to the polypeptide molecule structure associated with the first complex.

20. The method as in claim 1 further comprising:
predicting potential activity of molecules corresponding to molecular structures in the first complex.

21. The method as in claim 20 further comprising:
selecting the second interacting molecule structure in response to the predicted activity of molecules corresponding to molecular structures in the first complex.

22. The method as in claim 1 further comprising:
predicting activity of molecules corresponding to molecular structures in the second complex.

23. The method as in claim 22 further comprising:
selecting the third interacting molecule structure in response to the predicted activity of molecules corresponding to molecular structures in the second complex.

24. The method as in claim 1 further comprising:
predicting activity of molecules corresponding to molecular structures in the third complex.

25. The method as in claim 1 wherein predicting a structural model of the first complex includes at least one of: a 3-dimensional structure prediction, a space-filling structure prediction, a linear model structural prediction, a dynamic structural prediction or a structural model including molecular energy states.

26. The method as in claim 1 further comprising:
identifying a plurality of additional interacting molecule structures.

27. The method as in claim 1 further comprising:
predicting a structural model of a polypeptide molecule in complex, with a plurality of identified interacting molecule structures.

28. The method of claim 1 further comprising:
identifying a set of candidate interacting molecules that are associated with toxicity predictions for a mammal;
selecting a first interacting molecule from the identified set of candidate interacting molecules; and
predicting the molecule structure of the identified first interacting molecule.

29. The method of claim 1 further comprising:
identifying a set of candidate interacting molecules;
predicting the toxicity of the identified candidate interacting molecules; and
predicting the molecule structure of a group of the identified candidate interacting molecules.

30. The method of claim 29 further comprising:
selecting identified molecules having a predicted toxicity below a selected level.

31. The method of claim 29 further comprising:
selecting two or more identified molecules in reference to their predicted molecule structures as a group.

32. The method of claim 1 wherein the interacting molecule structures correspond to molecules that are associated with minimal toxicity to at least one of: a human, a domestic animal or a non-domestic animal.

33. The method as in claim 1 wherein the polypeptide molecule structure corresponds to a molecule that is causally associated with a disease state in at least one of: a human, a non-human mammal or an animal.

34. The method of claim 1 wherein at least one of the interacting molecule structures corresponds to a molecule that is associated with enzymatic modification of polypeptides.

35. The method of claim 1 wherein at least one of the interacting molecule structures corresponds to a molecule that is associated with a cellular degradation mechanism.

36. A method comprising:
identifying at least one polypeptide;
predicting at least one polypeptide structural model of at least one polypeptide;
identifying that at least one polypeptide structural model has two or more potential conformations;
identifying at least one structural model of at least one first interacting molecule that may associate with at least one of the potential conformations;
predicting a structural model of a first complex consisting essentially of at least one polypeptide and at least one first interacting molecule;
identifying at least one structural model of at least one second interacting molecule that may associate with the first complex; and
predicting a structural model of a second complex consisting essentially of at least one polypeptide, at least one first interacting molecule and at least one second interacting molecule.

37. The method as in claim 36, wherein the polypeptide is associated with a disease state.

38. The method as in claim 37, wherein the disease state affects at least one of: a human, a domestic animal, or a non-domestic animal.

39. The method as in claim 36, wherein at least one potential conformation of at least one polypeptide structural model is associated with a disease state.

40. The method as in claim 36, wherein at least one potential conformation of at least one polypeptide structural model is predicted to include at least one of: beta-sheet structure, polypeptide aggregate structure or fibril structure.

41. The method as in claim 36, further comprising:
predicting toxicity of a molecule corresponding to at least one interacting molecule structural model.

42. The method as in claim 36, wherein at least one interacting molecule is further predicted to interact with at least one enzyme.

43. The method as in claim 36, wherein at least one interacting molecule is further predicted to interact with at least one molecule that is associated with a cellular protein degradation pathway.

44. The method as in claim 36, wherein at least one interacting molecule is further predicted to interact with ubiquitin.

45. The method as in claim 36, further comprising:
selecting a series of N additional structural models of interacting molecules, wherein each structural model is predicted to associate with the N−1 complex structural model.

46. The method of claim 36, further comprising:
predicting a structural model of each of N complexes which consist essentially of the N−1 complex and the N interacting molecules.

47. A system comprising:
a computer readable medium including a computer program for use with a computer system, said computer program having one or more instructions including:
one or more instructions for defining a model structure of a polypeptide molecule;
one or more instructions for identifying a first interacting molecule structure predicted to be capable of associating with the polypeptide molecule structure;
one or more instructions for defining a model structure of a complex consisting essentially of the polypeptide molecule structure in association with the first interacting molecule structure; and
one or more instructions for identifying at least two additional interacting molecule structures that are predicted to be capable of associating with the polypeptide molecule structure and the first interacting molecule structure to form an inhibitory complex.

48. The system of claim 47, further comprising:
one or more instructions for defining a model structure of the inhibitory complex.

49. The system of claim 47, wherein the polypeptide molecule is associated with a disease state in at least one of: a human, a domestic animal, or a non-domestic animal.

50. The system of claim 47, wherein the model structure of a polypeptide molecule includes at least one of: beta-sheet structure, or fibril structure.

51. The system of claim 47, wherein the model structure of a polypeptide molecule is predicted to form aggregate structures.

52. The system of claim 47, wherein the model structure of a polypeptide molecule includes alternate conformations.

53. The system of claim 52, further comprising:
one or more instructions for predicting the probability of association of at least two alternate conformations of the molecule structure of the polypeptide molecule with at least one interacting molecule structure; and
one or more instructions for selecting an interacting molecule structure in reference to the probability of association.

54. The system of claim 52, wherein at least one alternate conformation is associated with a disease state.

55. The system of claim 47, further comprising:
one or more instructions for predicting the response of at least one cell to molecules corresponding to the molecule structures of the inhibitory complex.

56. The system of claim 47, further comprising:
one or more instructions for predicting the toxicity of: at least one interacting molecule, or the inhibitory complex.

57. The system of claim 56, further comprising:
one or more instructions for selecting at least one interacting molecule in reference to a predicted toxicity.
